(19) United States
(12) Patent Application Publication
(10) Pub. No.: US 2026/0012527 A1
(43) Pub. Date: Jan. 8, 2026

(54) SYSTEM FOR COMMUNICATION IN A MOBILE EQUIPMENT CABIN WITH EXTERNAL PERSONNEL

(71) Applicant: Caterpillar Inc., Peoria, IL (US)

(72) Inventor: Shaun CURRIER, Naperville, IL (US)

(73) Assignee: Caterpillar Inc., Peoria, IL (US)

(21) Appl. No.: 18/763,935

(22) Filed: Jul. 3, 2024

(51) Int. Cl. H04M 1/60; H04R 1/40; H04R 3/00; H04R 3/04

(52) U.S. Cl. CPC H04M 1/6008; H04R 1/406; H04R 3/005; H04R 3/04; H04R 2499/13

(57) ABSTRACT

Traditionally, mobile equipment, especially machinery used in construction worksites, can face significant challenges when communicating with external personnel during operation due to the heavy noise environment or from the noise created by the mobile equipment itself. Accordingly, a system for communicating in a mobile equipment cabin with external personnel is disclosed with a microphone array that can receive sound from an external source and convert the sound into an electrical signal, which has one or more processors in communication with the microphone array and can filter the electrical signal from the microphone array based on a height of the source of the sound and create a filtered signal. Furthermore, the one or more processors are in communication with a cabin speaker to receive the filtered signal, convert it into sound waves, and broadcast them to the mobile equipment cabin.

### TECHNICAL FIELD

The embodiments described herein are generally directed to a system for communication, and, more particularly, to the system for communication in a mobile equipment cabin with external personnel.

### BACKGROUND

Mobile equipment, especially machinery used in construction worksites, can face significant challenges when communicating with external personnel during operation. Due to the lack of visibility and high-noise areas, mobile equipment might enter active work zones without proper guidance, leading to collisions or accidents with the surrounding personnel. The mobile equipment operator may not have full visibility where a heavy object is being placed, such as in a hole in the ground. Without clear communication, personnel on the ground are at risk from the actions of mobile equipment and heavy objects. The absence of effective communication between mobile equipment operators and external personnel can put everyone at risk, including the operational efficiency and collaborative efforts for successful project execution. This can be especially dangerous if the mobile equipment is moving and loses communication with external personnel, leading to fatal accidents.

On the other hand, relying solely on visual or auditory signals for communication can be inadequate due to the pervasive noise levels. The intense sounds produced by mobile equipment operation in worksites can easily drown out signals, making it challenging for external personnel to effectively convey or receive critical information. Moreover, in emergency scenarios, the inability to hear signals clearly can impede prompt reactions and necessary evacuations. Therefore, while signals serve as valuable communication tools, their effectiveness in noisy environments is limited. A possible solution can be communication radios. However, this option is not always available and sufficient radios for all personnel on a worksite is not feasible. Furthermore, radios may have challenges tuning to the same channel of communication.

Accordingly, a system for communication in a mobile equipment cabin would offer a variety of benefits. Systems for communication in mobile equipment have been used in other contexts. For example, U.S. Pat. No. 6,894,621 describes an improved crane warning system that includes acceleration sensors, motion sensors, hydraulic sensors, remote communications and/or a camera. The crane warning system may include a crane warning device integrated into the device suspended from the crane. International Patent Pub. No. WO/2014/126281A1 describes a construction machine provided with a device for listening to the voice of an auxiliary worker around a working device. However, the mere audible warning system or listening to auxiliary workers may not be enough to prevent accidents or provide proper communication between a mobile equipment operator and external personnel. The present disclosure is directed toward a system for communication in a mobile equipment cabin with external personnel, in the context of construction and similar tasks, that overcomes this and other problems discovered by the inventors.

### SUMMARY

In an embodiment, a system for communicating in a mobile equipment cabin with external personnel, the system comprises: a microphone array configured to receive sound from an external source and convert the sound into an electrical signal; one or more processors in communication with the microphone array and configured to filter the electrical signal from the microphone array based on a height of the source of the sound and create a filtered signal; and a cabin speaker configured to receive the filtered signal from the one or more processors, convert the filtered signal into sound waves, and broadcast the sound waves into the mobile equipment cabin.

In an embodiment, a method for communicating a mobile equipment cabin with external personnel, the method comprises: receiving a sound of from a source external to the cabin at a microphone array; converting the sound into an electrical signal; filtering the electrical signal received by the microphone array based on a height of the source of the sound and creating a filtered signal by one or more processors; transmitting the electrical signals to a cabin speaker; processing the electrical signals into sound waves at the cabin speaker; and broadcasting the sound waves into the mobile equipment cabin.

In an embodiment, a two-way communication system between a mobile equipment cabin and external personnel, the system comprises: a microphone array configured to receive sound from an external source and convert the sound into an electrical signal; one or more processors in communication array with the microphone and configured to filter the electrical signal from the microphone array based on a height of the source of the sound and create a filtered signal; a cabin speaker configured to receive the filtered signals from the one or more processors, convert the electrical filtered signal into sound waves, and broadcast the sound waves to the mobile equipment cabin; a cabin microphone array located in the mobile equipment cabin configured to receive sound from the operator and convert the sound into an electrical signal; one or more processors in communication with the cabin microphone array configured to filter the electrical signal from the cabin microphone array and create a filtered signal; and one or more external speakers configured to receive the filtered signal from the one or more processors, convert the filtered signal into sound waves, and broadcast the sound waves to the external personnel.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a side view of a mobile equipment with a system for communicating in a mobile equipment cabin with external personnel, according to an embodiment;

FIG. 2 illustrates a functional block diagram of an example controller, by which one or more of the processes described herein, may be executed, according to an embodiment;

FIG. 3 illustrates a one-way process for communicating in a mobile equipment cabin with external personnel, according to an embodiment; and

FIG. 4 illustrates a two-way process for communicating in a mobile equipment cabin with external personnel, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

As used herein, a reference numeral with an appended letter will be used to refer to a specific component, whereas the same reference numeral without any appended letter will be used to refer collectively to a plurality of the component or to refer to a generic or arbitrary instance of the component. In addition, the terms “respective” and “respectively” signify an association between members of a group of first items and members of a group of second items. For example, the phrase “each component A connected to a respective component B” would signify A1 connected to B1, A2 connected to B2, and so on and so forth, up to AN connected to BN.

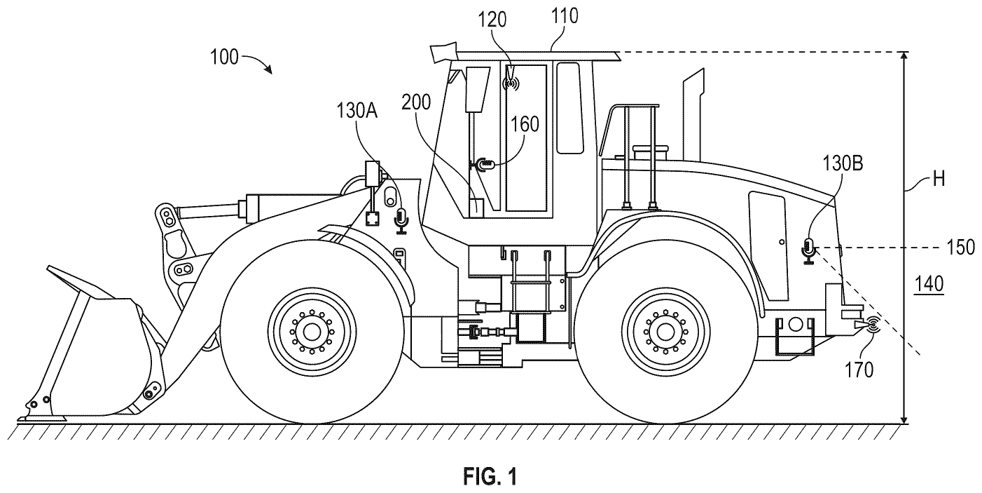

FIG. 1 illustrates a side view of a mobile equipment 100 with a system for communicating in a mobile equipment cabin 110 with external personnel, according to an embodiment. Mobile equipment 100 is illustrated as a wheel loader. However, mobile equipment 100 can be any mobile equipment that utilizes a system for communicating in a mobile equipment cabin 110 with external personnel. Other examples of mobile equipment 100 include, without limitation, an excavator, dump truck, asphalt paver, backhoe loader, skid steer, track loader, cold planer, compactor, dozer, electric rope shovel, forest machine, hydraulic mining shovel, material handler, motor grader, pipe-layer, road reclaimer, telehandler, tractor-scraper, or the like. Mobile equipment 100 can be operated by a human (e.g., locally or remotely) and/or by an autonomous system.

In the illustrated example, mobile equipment 100 comprises a system for communicating in a mobile equipment cabin 110 with external personnel. The system for communicating in a mobile equipment cabin 110 with external personnel in mobile equipment 100 comprises a mobile equipment cabin 110, one or more cabin speaker 120, one or more microphone array 130 that receive a source sound 140 (e.g., a human voice, etc.) based on a range height 150 (e.g. the average human mouth height range) indicated by the dashed lines, and a controller 200 that processes the sound converted into electrical signals by microphone array 130. Further, the system for communicating in a mobile equipment cabin 110 with external personnel can comprise a cabin microphone array 160 and an external speaker 170 when intended as a two-way communication system in mobile equipment 100. However, it should be understood that disclosed embodiments do not require mobile equipment 100 to comprise a system for communicating in a mobile equipment cabin 110 with external personnel.

Mobile equipment 100 can comprise a mobile equipment cabin 110. Mobile equipment cabin 110 can serve multiple functions, primarily focusing on providing protection and a comfortable environment for the operator. Mobile equipment cabin 110 can shield the operator from external elements such as weather conditions, dust, and debris encountered during its operation. Moreover, mobile equipment cabin 110 also houses the controls and instrumentation panels that enable the operator to monitor and manage mobile equipment's 100 performance efficiently. Additionally, mobile equipment cabin 110 can be equipped with amenities like climate control, sound insulation, and suspension systems, further enhancing comfort and usability.

As mentioned, mobile equipment cabin 110 can partially shield the operator from external noises. However, the level of noise protection can depend on mobile equipment cabin 110 type. Mobile equipment cabin 110 can come in various types to cater to different operational needs and environments depending on mobile equipment 100. For example, an open mobile equipment cabin 110, also known as ROPS (Roll-Over Protective Structure) cabins, is characterized by their basic structure that includes a frame overhead and sometimes on the sides, offering minimal protection from elements like rain, noise, and sun but prioritizing visibility and airflow. On the other hand, closed mobile equipment cabins 110 can provide a fully enclosed environment that shields the operator from weather conditions and noise. A closed mobile equipment cabin 110 can be achieved through windows made of glass or polycarbonate for visibility and insulation. Overall, mobile equipment cabin 110 type depends on the need for the task and the type of mobile equipment 100 being operated.

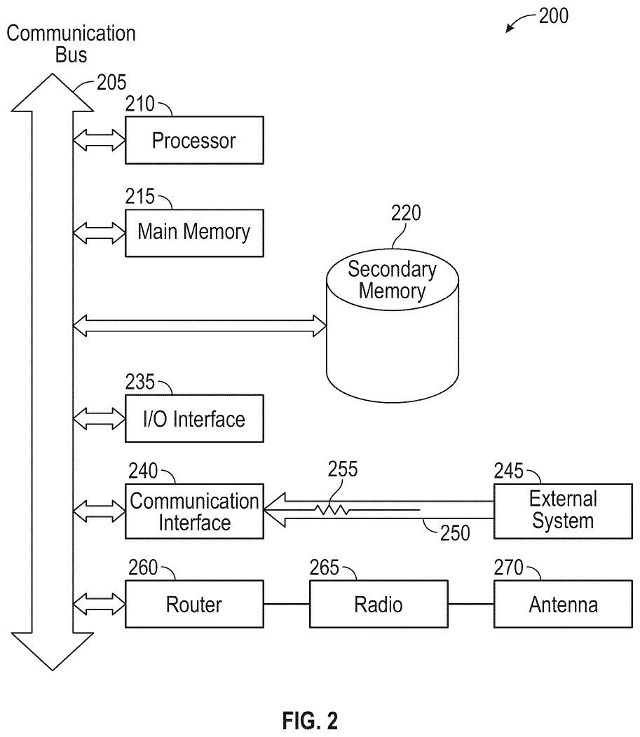

Mobile equipment 100 can comprise one or more cabin speaker 120 that projects sound into the mobile equipment cabin 110. Cabin speaker 120 is configured to receive a filtered signal from one or more processors 210 (see FIG. 2) of controller 200 and convert the filtered signal into sound waves to broadcast into mobile equipment cabin 110. In mobile equipment cabin 110, cabin speaker 120 can serve multiple functions for communication and safety. Cabin speaker 120 can be integrated into mobile equipment cabin 110 or simply next to it. The positioning of cabin speaker 120 is not limited to the interior of mobile equipment cabin 110. Additionally, cabin speaker 120 can facilitate hands-free communication. For example, cabin speaker 120 can communicate via Bluetooth with microphone array 130, allowing drivers to maintain focus on the road while staying connected with external personnel. Other features of cabin speaker 120 can include active noise cancellation, creating a quieter cabin environment by emitting sound waves that counteract undesirable noise frequencies. It should be understood that cabin speaker 120 can be any type or model speaker commercially available.

As mentioned, mobile equipment 100 comprises one or more microphone array 130 that receive sound from an external source (personnel) and convert it into an electrical signal. Microphone array 130 can be located in multiple areas of mobile equipment 100. As shown in FIG. 1, in one embodiment microphone array 130A is located towards the front of mobile equipment 100 and microphone array 130B is located toward the rear end of mobile equipment 100. The function of microphone array 130 is to capture sound from multiple directions and different sound sources. The structure of microphone array 130 can consist of multiple microphones arranged in a specific configuration, typically in a linear or circular array. For example, a linear microphone array 130 configuration may be positioned along the bumper of mobile equipment 100 to capture sound from different angles, ensuring clear voice recognition regardless of the external personnel's position. On the other hand, a circular microphone array 130 configuration can be integrated into the bumper or mounted on the hood of mobile equipment 100, capturing sound uniformly from all directions within mobile equipment 100. With this structure, microphone array 130 can provide signals which can be used to enhance the reception of desired sound sources 140 while suppressing unwanted noise and interference. However, different designs of microphone array 130 can serve specific configurations and purposes for specific mobile equipment 100.

Microphone array's 130 spatial sound capturing ability allows for signals microphone array 130 to effectively isolate sound coming from source sound 140 or to detect the directionality of source sound 140. Thus, the primary function of microphone array 130 is to spatially capture and process source sound 140 to improve signal quality, enhance directionality, and facilitate communication with mobile equipment cabin 110 through cabin speaker 120. Further, microphone array 130 can be configured to receive sound from source sound 140 and convert the sound into an electrical signal. Next, one or more processors 210 (shown in FIG. 2) can be configured to filter the electrical signal from microphone array 130 based on a range height 150 of source sound 140 and create a filtered signal. The present application is intended to apply range height 150 signal of microphone array 130 based on a human mouth height from the ground. For instance, range height 150 in certain mobile equipment 100 can be ranged from above the bumper and below microphone array 130, or above the bumper and below the hood of mobile equipment 100. However, the standard range height 150 can be modified by system or operator to be dynamically based on mobile equipment 100 height. Microphone array 130 location and range height 150 in FIG. 1 are not shown at scale. Range height 150 can vary and should not be necessarily coincident with the example shown.

Alternatively, all these functions can be performed by one or more processors 210 in microphone array 130, a separate processor 210 in controller 200, or a combination of a processor 210 in microphone array 130 and a separate processor 210 in controller 200. Furthermore, it should be understood that one or more processors 210 can be part of microphone array 130 or an independent system (controller 200) or both.

Further, the different components of mobile equipment 100 with a system for communicating in a mobile equipment cabin 110 with external personnel can be connected through wires or wirelessly. Microphone array 130 can be configured to communicate with controller's 200 processor 210 (e.g., to receive electrical signals, etc.) via a wired connection, to then communicate with cabin speaker 120. For example, one or more cables can run from microphone 130 through controller 200, and finally connecting with cabin speaker 120. Alternatively or additionally, microphone array 130 can be configured to communicate with controller 200 via wireless communication. For example, controller 200 can comprise a wireless receiver or transceiver, and microphone array 130 can comprise a wireless transmitter or transceiver that is configured to communicate with the wireless receiver or transceiver of controller 200 via a standard or non-standard wireless communication protocol.

Source sound 140 entering microphone array 130 can be limited based on a specific area, location, height, and/or frequency. For example, controller's 200 processor 210 can be configured to apply a pass filter based on the frequency range of human voices. Moreover, processor 210 can further comprise a filter for the ego machine noise coming from source sound 140 or the external sound as a whole. Processor 210 can use frequency and location filters on microphone array 130 signals to filter out ego machine noise such as the engine noise, pump noise, valve noise, and fan noise. These are noises that would most commonly prevent communication between the operator in mobile equipment cabin 110 and external personnel.

A bearing filter application is another feature of mobile equipment 100 with a system for communicating in a mobile equipment cabin 110 with external personnel. A bearing filter allows the operator to have direct control over microphone array 130 to turn a dial which would point a spatial selector in a bearing direction (i.e. compass direction) at the person intended to communicate with. Such a filter can improve the clarity of the signal received by microphone array 130 if there are a lot of other noises coming from around source sound 140. Therefore, processor 210 can easily filter pollution noise based on the bearing direction and create the filtered signal.

Finally, mobile equipment 100 with a system for communicating in a mobile equipment cabin 110 with external personnel can apply a pass and/or stop filter. The term “filter” for both “filtering something out” (stopping) and “filtering other things out” (passing) is used to define the sounds that will “pass” or be “stopped” by mobile equipment 100 with a system for communicating in a mobile equipment cabin 110 with external personnel. For example, range height 150 filter for a normal human mouth height is a pass filter but the ego machine noise filters are stop filters. It should be noted that the previous features can be achieved through any type or model microphone array 130 or processor 210 commercially available. Further, the filtering process can occur through the use of artificial intelligence-based technology.

Mobile equipment 100 can comprise a controller 200. In summary, controller 200 serves as the brain of mobile equipment 100, responsible for interpreting commands, executing tasks, and ensuring smooth operation according to predefined instructions or programmable logic. Controller 200 can integrate sensors, actuators, and interface devices to monitor conditions, receive input signals, and output commands, effectively orchestrating the precise movements and functions of mobile equipment 200 components. Controller 200 is details are described in FIG. 2 below.

In an alternative embodiment, mobile equipment 100 can further comprise cabin microphone array 160 and an external speaker 170. Cabin microphone array 160 and external speaker 170 are commonly present when there is an intended two-way communication system between operator and external personnel. By having cabin microphone array 160, the operator can directly send voice messages to external personnel in the same way as external personnel does using microphone array 130. Further, by having external speaker 170, the external personnel can directly receive voice messages from operator in the same way as the operator does using cabin speaker 120.

FIG. 2 illustrates a functional block diagram of an example controller 200, by which one or more of the processes described herein, can be executed, according to an embodiment. Controller 200 can be a wired or wireless system that is used in connection with any of the various embodiments described herein. For example, controller 200 can be used as or in conjunction with one or more of the functions, processes, or methods described herein (e.g., to store and/or execute the implementing software), and can represent components of mobile equipment 100 (e.g., cabin speaker 120, microphone array 130, cabin microphone array 160, camera(s) or other sensors, etc.), external speaker 170, and/or other processing devices described herein. Controller 200 can be a server or any conventional personal computer, or any other processor-enabled device that is capable of wired or wireless data communication. Other computer systems and/or architectures can be also used, as will be clear to those skilled in the art.

Controller 200 preferably includes one or more processors 210. Processor(s) 210 can comprise a central processing unit (CPU). Additional processors can be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a processor subordinate to the main processing system (e.g., back-end processor), an additional microprocessor or controller for dual or multiple processor systems, and/or a coprocessor. Such auxiliary processors can be discrete processors or can be integrated with processor 210. Examples of processors which can be used with controller 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 can include a data channel for facilitating information transfer between storage and other peripheral components of controller 200. Furthermore, communication bus 205 can provide a set of signals used for communication with processor 210, including a data bus, address bus, and/or control bus (not shown). Communication bus 205 can comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE), and/or the like.

Processor 210 can be operatively connected to a database, microphone array 130, and/or cabin speaker 120. It should be noted that, while not shown, additional databases can be linked to controller 200 in a known manner. Furthermore, these databases can be external to controller 200. In an example, the database(s) can include virtual machine model information (e.g., predetermined source sound 140 ranges, proportions, limitations, etc.) and machine to virtual model mapping directions. The database(s) can be stored locally on mobile equipment 100 or can be located separate from mobile equipment 100 and accessed remotely. Controller 200 can include a communication module that can provide information to the database(s) such as machine sensor information.

Controller 200 preferably includes a main memory 215 and can also include a secondary memory 220. Main memory 215 provides storage of instructions and data for programs executing on processor 210, such as any of the software discussed herein. It should be understood that programs stored in the memory and executed by processor 210 can be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 can include, for example, semiconductor-based memory, such as programmable read-only memory (PROM), erasable programmable read-only memory (EPROM), electrically erasable read-only memory (EEPROM), flash memory (block-oriented memory similar to EEPROM), and the like.

In an embodiment, I/O interface 235 provides an interface between one or more components of controller 200 and one or more input and/or output devices. Example input devices include, without limitation, sensors, keyboards, touch screens or other touch-sensitive devices, joysticks, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device can be combined, such as in the case of a touch panel display (e.g., display console, smartphone, tablet computer, mobile device, etc.).

Controller 200 can include a communication interface 240. Communication interface 240 allows software and data to be transferred between controller 200 and an external system 245. For example, computer software or executable code can be transferred to controller 200 from a network server (e.g., platform 150) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing controller 200 with a network (e.g., network 140) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but can also implement customized or non-standard interface protocols as well.

Software and data transferred via communication interface 240 are generally in the form of electrical communication signals 255. These signals 255 can be provided to communication interface 240 via a communication channel 250. In an embodiment, communication channel 250 can be a wired or wireless network (e.g., network 140), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Controller 200 can also include wireless communication components that facilitate wireless communication over a voice network and/or a data network. The wireless communication components, which can correspond to communication module in the event that controller 200 implements controller 120, can comprise an antenna 270, a radio 265, and a router 260. In an embodiment, router 260 and radio 265 can be combined into a single component. In any case, router 260 is communicatively coupled with processor(s) 210. In the case that controller 200 is controller 120, router 260 can separate the private local area network (LAN) of work machine 110 from public network 140. In controller 200, radio frequency (RF) signals are transmitted and received over the air by antenna 270 under the management of radio 265.

Computer-executable code (e.g., computer programs, such as the disclosed software) is stored in main memory 215 and/or secondary memory 220. Computer-executable code can also be received via communication interface 240 and/or communication module (e.g., comprising router 260, radio 265, and antenna 270) and stored in main memory 215 and/or secondary memory 220. Such computer programs, when executed, can enable controller 200 to perform the various functions of the disclosed embodiments described elsewhere herein.

In this description, the term “computer-readable medium” is used to refer to any non-transitory computer-readable storage media used to provide computer-executable code and/or other data to or within controller 200. Examples of such media include main memory 215, secondary memory 220, external system 245, and any peripheral device communicatively coupled with communication interface 240 (including a network information server or other network device). These non-transitory computer-readable media are means for providing software and/or other data for utilization in controller 200.

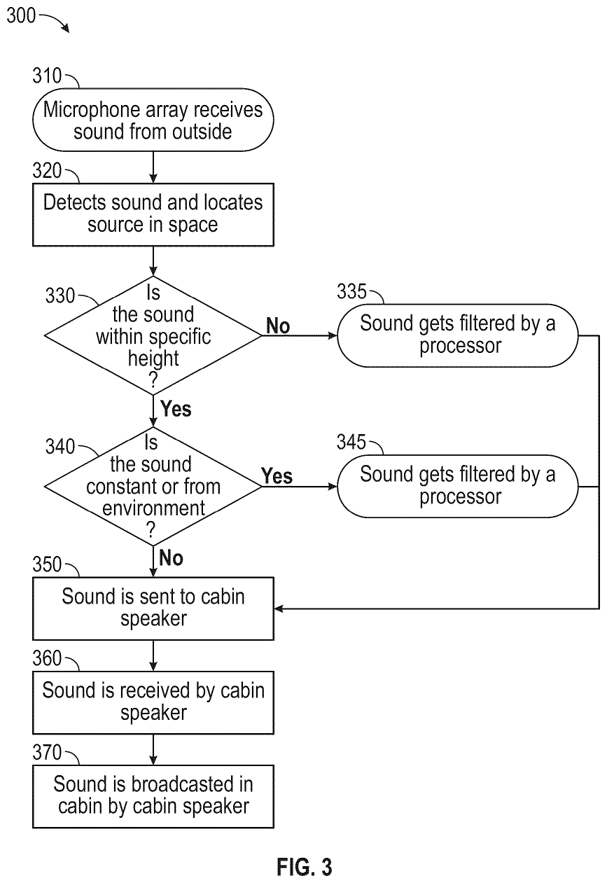

FIG. 3 illustrates a one-way process for communicating in a mobile equipment cabin 110 with external personnel, according to an embodiment. Process 300 can be implemented by mobile equipment 100 with a system for communicating in a mobile equipment cabin 110 with external personnel. While process 300 is illustrated with a certain arrangement and ordering of subprocesses, process 300 can be implemented with fewer, more, or different subprocesses and a different arrangement and/or ordering of subprocesses. In addition, it should be understood that any subprocess, which does not depend on the completion of another subprocess, can be executed before, after, or in parallel with that other independent subprocess, even if the subprocesses are described or illustrated in a particular order. It should be understood that the sound is represented in its different phases throughout process 300 detailed description. These include source sound 140, electrical signal, filtered signal, and/or sound waves. For simplicity, it is represented as “sound” in FIG. 3.

In subprocess 310, microphone array 130 receives source sound 140 from external personnel and source sound 140 is converted it into an electrical signal by microphone array 130. Next, in subprocess 320, source sound 140 converted to an electrical signal is detected and located by one or more processors 210 in microphone array 130, in a separate processor 210, or a combination of a processor 210 in microphone array 130 and a separate processor 210. As shown in subprocess 330, processor 210 determines if source sound 140 is within range height 150. If source sound 140 is not within range height 150, then the sound is filtered by processor 210 in subprocess 335. If source sound 140 is within range height 150, source sound 140 is not filtered based on range height 150. Similar to subprocess 330, in subprocess 340, processor 210 determines if source sound 140 is constant or from the surrounding environment. In other words, processor 210 determines if source sound 140 contains pollution noise. If source sound 140 contains pollution noise, processor 210 filters source sound 140 in subprocess 345. Otherwise, source sound 140 is not filtered. Finally, processor 210 transforms source sound 140 into a filtered signal with the leftover sound that is transmitted to cabin speaker 120.

In subprocess 350, the filtered signal is transmitted to cabin speaker 120. Further, the filtered signal is received by cabin speaker 120 in subprocess 360. Finally, the filtered signal is converted into sound waves by cabin speaker 120 and broadcasted into mobile equipment cabin 110.

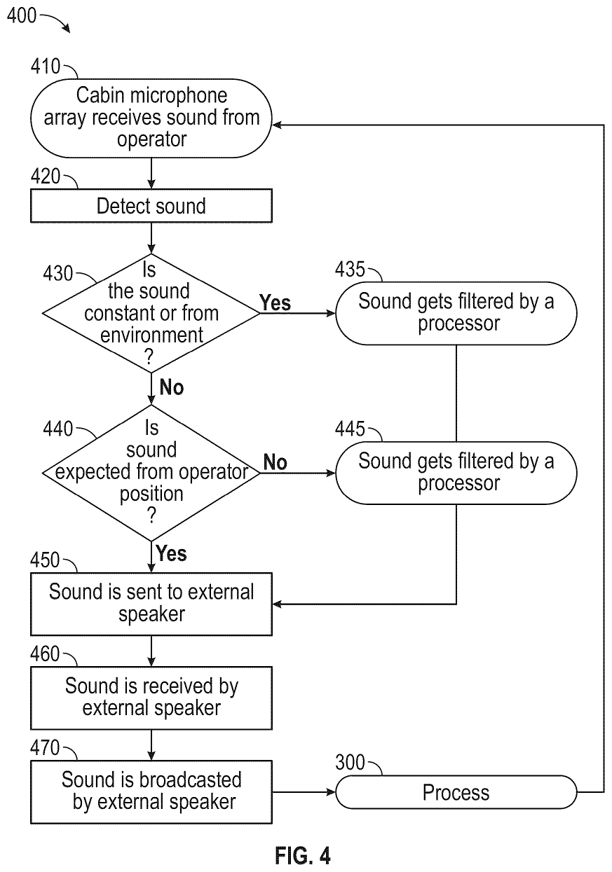

FIG. 4 illustrates a two-way process for communicating in a mobile equipment cabin 110 with external personnel, according to an embodiment. Process 400 can be implemented by mobile equipment 100 with a system for communicating in a mobile equipment cabin 110 with external personnel. While process 400 is illustrated with a certain arrangement and ordering of subprocesses, process 400 can be implemented with fewer, more, or different subprocesses and a different arrangement and/or ordering of subprocesses. In addition, it should be understood that any subprocess, which does not depend on the completion of another subprocess, can be executed before, after, or in parallel with that other independent subprocess, even if the subprocesses are described or illustrated in a particular order. It should be understood that the sound is represented in its different phases throughout process 400 detailed description. These include the sound from operator, electrical signal, filtered signal, and/or sound waves. For simplicity, it is represented as “sound” in FIG. 4. Further, it should be understood that process 400 is not exclusive to a two-way process for communication but can also be two separate one-way processes of communication.

In subprocess 410, cabin microphone array 160 receives a sound from operator and converts it into an electrical signal. Next, in subprocess 420, cabin microphone array 160 detects the electrical signal through one or more processor 210. As shown in subprocess 420, processor 210 determines the electrical signal is constant or from the surrounding environment. In other words, processor 210 determines the electrical signal contains pollution noise in subprocess 430. If the electrical signal contains pollution noise, processor 210 filters source sound 140 in subprocess 435. Otherwise, the electrical signal is not filtered. Similar to subprocess 430, in subprocess 440, processor 210 determines if source sound 140 is expected from the operator's position. This means that source sound 140 does not contain pollution noise or ego machine noise (e.g. engine noise). If source sound 140 is expected, then source sound 140 is not filtered by processor 210. In other words, processor 210 determines if source sound 140 contains pollution noise. If the electrical signal contains pollution noise not expected from the operator's position, processor 210 filters source sound 140 in subprocess 445. Finally, processor 210 transforms the electrical signal into a filtered signal with the leftover sound that is transmitted to external speaker 170.

In subprocess 450, the filtered signal is transmitted to external speaker 170. Further, the filtered signal is received by external speaker 170 in subprocess 460. Finally, the filtered signal is converted into sound waves by external speaker 170 and broadcasted to the external personnel in subprocess 470. Communication can come and go both ways via process 300 and/or process 400.

### INDUSTRIAL APPLICABILITY

Traditionally, mobile equipment 100 in construction sites can encounter environments with lack of visibility and high-noise areas. Because of these factors, mobile equipment 100 might enter active work zones without proper guidance, leading to collisions or accidents with the surrounding personnel. The absence of effective communication between mobile equipment's 100 operators and external personnel can put everyone at risk, including the operational efficiency and collaborative efforts for successful project execution. This can be especially dangerous if mobile equipment 100 is moving and loses communication with external personnel, leading to fatal accidents.

Accordingly, a system for communicating in a mobile equipment cabin 110 with external personnel is disclosed with a microphone array 130 that can receive sound from an external source and convert the sound into an electrical signal, which has one or more processors 210 in communication with microphone array 130 and can filter the electrical signal from microphone array 130 based on a height of the source of the sound and create a filtered signal. Furthermore, one or more processors 210 are in communication with a cabin speaker 120 to receive the filtered signal, convert it into sound waves, and broadcast them to mobile equipment cabin 110.

A system for communicating in a mobile equipment cabin 110 with external personnel offers a variety of benefits, including improved communication between personnel on the ground and mobile equipment 100 operator. For example, in high-noise work zones, such a system for communicating in a mobile equipment cabin 110 with external personnel allows real-time coordination between mobile equipment 100 operators and external personnel, enhancing operational efficiency and safety. Further, operators can communicate field conditions, mobile equipment 100 status, or emergency situations instantly, enabling swift response and mitigation of potential risks. In construction, a system for communicating in a mobile equipment cabin 110 with external personnel facilitates seamless interaction between mobile equipment 100 operators and ground personnel, optimizing workflow and ensuring adherence to safety protocols.

It will be understood that the benefits and advantages described above can relate to one embodiment or can relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of industrial context or with a particular type of mobile equipment 100. Hence, although the present embodiments are, for convenience of explanation, depicted and described as being implemented with construction equipment, it will be appreciated that it can be implemented for various other types of equipment, and in various other environments. Furthermore, there is no intention to be bound by any theory presented in any preceding section. It is also understood that the illustrations can include exaggerated dimensions and graphical representation to better illustrate the referenced items shown, and are not considered limiting unless expressly stated as such.

What is claimed is:

1. A system for communicating in a mobile equipment cabin with external personnel, the system comprising:
a microphone array configured to
receive sound from an external source and convert the sound into an electrical signal;
one or more processors in communication with the microphone array and configured to filter the electrical signal from the microphone array based on a height of the source of the sound and create a filtered signal; and
a cabin speaker configured to
receive the filtered signal from the one or more processors,
convert the filtered signal into sound waves, and
broadcast the sound waves into the mobile equipment cabin.

2. The system of claim 1, further comprising a plurality of microphone arrays.

3. The system of claim 1, wherein the one or more processors are configured to filter the electrical signal received from the microphone array based on an ego machine noise and using a location and a frequency of the sound source.

4. The system of claim 1, wherein the one or more processors are further configured to apply a pass filter based on the frequency range of human voices.

5. The system of claim 1, further comprising:
a cabin microphone array located in the mobile equipment cabin configured to
receive sound from an operator and convert the sound into an electrical signal;
one or more processors in communication with the cabin microphone array configured to filter the electrical signal from the cabin microphone array and create a filtered signal; and
one or more external speakers configured to
receive the filtered signal from the one or more processors,
convert the filtered signal into sound waves, and
broadcast the sound waves to the external personnel.

6. The system of claim 1, wherein the operator can turn a dial to direct the microphone array to a bearing direction of the external personal communicating with the sound; and
wherein the one or more processors are further configured to filter the electrical signal received from the microphone array based on the bearing direction and create the filtered signal.

7. The system of claim 1, wherein the microphone array can be located at different heights above the ground depending on the mobile equipment.

8. The system of claim 1, wherein the one or more processor are further to configured to determine the height of the source sound.

9. A method for communicating a mobile equipment cabin with external personnel, the method comprising:
receiving a sound of from a source external to the cabin at a microphone array;
converting the sound into an electrical signal;
filtering the electrical signal received by the microphone array based on a height of the source of the sound and creating a filtered signal by one or more processors;
transmitting the electrical signals to a cabin speaker;
processing the electrical signals into sound waves at the cabin speaker; and
broadcasting the sound waves into the mobile equipment cabin.

10. The method of claim 9, further comprising a plurality of microphone arrays.

11. The method of claim 9, wherein the one or more processors are configured to filter the electrical signal received from the microphone array based on an ego machine noise and using a location and a frequency of the sound source.

12. The method of claim 9, the one or more processors further comprising applying a pass filtering based on the frequency range of human voices.

13. The method of claim 9, further comprising:
receiving sound from an operator at a cabin microphone array;
converting the sound into an electrical signal;
filtering the electrical signal received by the cabin microphone array and creating a filtered signal by one or more processors;
transmitting the filtered signal to an external speaker;
processing the filtered signal into sound waves at the external speaker; and
broadcasting the sound waves to external personnel.

14. The method of claim 9, further comprising turning a dial to direct the microphone array to a bearing direction of the external personal communicating with the sound;
wherein the one or more processors are further configured to filter the electrical signal received from the microphone array based on the bearing direction and create the filtered signal.

15. The method of claim 9, wherein the microphone array can be located at different heights above the ground depending on the mobile equipment.

16. The method of claim 9, wherein the one or more processor are further to configured to determine the height of the source sound.

17. A two-way communication system between a mobile equipment cabin and external personnel, the system comprising:
a microphone array configured to
receive sound from an external source and convert the sound into an electrical signal;
one or more processors in communication array with the microphone and configured to filter the electrical signal from the microphone array based on a height of the source of the sound and create a filtered signal;
a cabin speaker configured to
receive the filtered signals from the one or more processors,
convert the electrical filtered signal into sound waves, and
broadcast the sound waves to the mobile equipment cabin;
a cabin microphone array located in the mobile equipment cabin configured to
receive sound from the operator and convert the sound into an electrical signal;
one or more processors in communication with the cabin microphone array configured to filter the electrical signal from the cabin microphone array and create a filtered signal; and
one or more external speakers configured to
receive the filtered signal from the one or more processors,
convert the filtered signal into sound waves, and
broadcast the sound waves to the external personnel.

18. The system of claim 17, wherein the one or more processors are further configured to apply a pass filter based on the frequency range of human voices.

19. The system of claim 17, wherein the one or more processors are configured to filter the electrical signal received from the microphone array based on an ego machine noise and using a location and a frequency of the sound source.

20. The system of claim 17, wherein the one or more processor are further to configured to determine the height of the source sound.
